(19) United States
(12) Patent Application Publication
(10) Pub. No.: US 2011/0190937 A1
(43) Pub. Date: Aug. 4, 2011

(54) Medical Work Station And Operating Device For Manually Moving A Robot Arm Of A Medical Work Station

(75) Inventor: Tobias Ortmaier, Hemmingen (DE)

(73) Assignee: KUKA LABORATORIES GMBH, Augsburg (DE)

(21) Appl. No.: 13/061,361

(22) PCT Filed: Aug. 19, 2009
(86) PCT No.: PCT/EP2009/006010

§ 371 Date: Apr. 11, 2011

(30) Foreign Application Priority Data
Aug. 29, 2008 (DE) 10 2008 041 709.2

(51) Int. Cl. B25J 13/08

(52) U.S. Cl. 700/264; 901/2

(57) ABSTRACT

The invention relates to a medical work station and to an operating device (1) for manually moving a robot arm (M1-M3) of a medical work station. The operating device (1) comprises a control device (5), a manual first input device (E2) coupled with the control device (5), and a screen (6). The control device (5) comprises an interface (8), which is provided in order to be connected to a hospital data network (9). The control device (5) is arranged to produce a first signal for controlling a motion of a first robot arm (M2) provided for treating a living being (P), provided as a result of a manual motion of the first input device (E2), so that the first robot arm (M2) performs a motion corresponding to the manual motion, to fetch data associated with the living being (P) through the interface (8) and the hospital data network (9), and to depict informational content (11) associated with the data on the screen (6).

The invention relates to a medical work station and an operating device for the manual movement of a robot arm of a medical work station.

EP 0 883 376 B1 discloses a medical work station having a plurality of robot arms provided for treating a patient, which are movable manually using an operating device of the medical work station. The operating device includes a control device, and first and second input devices coupled with the latter. If the input devices are moved, the control device generates a signal to move the robot arms accordingly.

The object of the invention is to specify prerequisites for a more flexible operating device for such a medical work station.

The object of the invention is fulfilled by an operating device for manually moving a robot arm of a medical work station, having a control device which is set up to generate a signal intended to control a movement of a first robot arm provided for treating a living being, a first input device coupled with the control device, the control device generating the first signal on the basis of a manual movement of the first input device, so that the first robot arm executes a movement corresponding to the manual movement, and a display screen, the control device having an interface which is intended to be connected to a hospital data network and the control device being set up to retrieve data associated with the living being via the interface and the hospital data network and to display informational content associated with the data on the screen.

Another aspect of the invention relates to a medical work station that has the operating device according to the invention and at least one robot arm provided for treating the living being, the movement of the robot arm being controllable manually by means of the operating device.

The operating device according to the invention or the medical work station according to the invention are intended for example for a doctor to treat the living being by means of one or more robot arms. The robot arm or robot arms may be provided for example with a medical instrument, in particular a minimally invasive medical instrument, the doctor moving the robot arm or robot arms, and hence the medical instrument, by means of the manual input device. The robot arm may be moved for example in six degrees of freedom. The input device may have for example the same number of degrees of freedom or more degrees of freedom than the robot arm being moved. A relatively simple manual movement of the robot arm or of the instrument tip results, based on the manual movement of the robot arm using the input device. The medical instrument may likewise be activated, in particular when employed in minimally invasive surgery; that is, it may include drives of its own, provided with motors, transmissions, etc.

The operating device according to the invention has, in addition to the first input device, the control device coupled with the latter. Based on the movement of the first input device, the control device generates the first signal, by means of which the movement of the first robot arm is controlled corresponding to the movement of the first input device. The control device may for example activate the first robot arm directly, or may be connected to another control device which activates drives to move the first robot arm. A processing of the first signal may also be undertaken, for example a filtering and/or scaling.

The operating device according to the invention may however also have a manual second input device, by means of which the movement of a second robot arm of the medical work station may be controlled manually. This allows the doctor treating the living being to manually control the movement of two robot arms simultaneously. The second input device may in particular have exactly as many degrees of freedom as, or more degrees of freedom than the second robot arm.

The operating device according to the invention also includes the display screen, which is provided in particular to display a movement of the first robot arm and/or of the second robot arm if applicable, and/or of the instruments associated with the robot arms. For example, if a camera is attached to the robot arm, or if the instrument attached to the robot arm includes a camera, then the screen is provided to display pictures taken with that camera.

The control device of the operating device according to the invention also has the interface via which the operating device according to the invention or its control device may be connected to the hospital data network. The hospital data network is connected for example to a so-called PACS, so that the doctor treating the living being is able to retrieve data associated with the living being and existing for example in DICOM format via the interface by means of the operating device according to the invention, so that the informational contents associated with the data are displayed using the screen of the operating device according to the invention. The data, which have been produced in particular prior to treatment of the living being with the first robot arm, are associated for example with the clinical record of the living being, and/or the informational content includes for example pictures, in particular pictures of the living being taken with an imaging medical device, such as x-ray, ultrasound or magnetic resonance images. Thus the doctor is enabled to retrieve information associated with the living being in a relatively simple way during the treatment of the living being with the robot arm, and to display the information on the screen.

According to one embodiment of the operating device according to the invention, its control device and the latter's first input device is set up to change the informational content displayed on the screen by means of the first input device, and/or to retrieve the data via the interface by operating the first input device. The operating device according to the invention includes the first input device, which, similar to input devices of conventional operating devices, is provided to move the first robot arm. Since according to this variant of the operating device according to the invention the first input is additionally designed to change the information displayed on the screen or to retrieve the data via the interface, no additional input means, such as a computer mouse, are needed for such a change or such retrieval. In particular, no other work station is necessary to retrieve and view the data associated with the patient. This represents a significant simplification of the operation for the operator, since he does not have to leave the work station to view the data and does not have to interrupt the operation. This is also accompanied by a reduction in costs. A change in the displayed informational content means, among other things, a change in how it is displayed, for example navigating within the informational content, and/or a change in the data associated with the informational content. In particular, it also includes superimposing the data of the camera on the patient data in order to display special anatomical structures appropriately. This technique is known to a person skilled in the art by the term “augmented reality.” Special structures may be for example blood vessels that are hidden in the camera image, visibly only in the data associated with the patient, unintentional damage to which must be avoided.

The operating device according to the invention, or the medical work station according to the invention, may have a manual second input device coupled with the control device, the control device being set up to generate a second signal based on a manual movement of the second input device, on the basis of which a medical second robot arm provided to treat the living being executes a movement corresponding to the manual movement of the second input device, the control device and the second input device being set up to change the informational content displayed on the screen by means of the second input device. On the basis of this variant, it is possible that the doctor treating the living being may change the displayed informational content with both input devices. The control device may for example activate the robot arms directly, or may be connected to another control device which activates drives to move the robot arms. In the second case, if a plurality of robot arms are used, a single control device may jointly activate all or several of the robot arms directly, or an individual control device which is activated by the control device of the operating device according to the invention may be associated with each individual robot arm.

According to one variant of the operating device according to the invention, the latter has a switching device coupled with the control device, where the control device either generates the first signal based on the manual movement of the first input device, on the basis of an activation of the switching device, or changes the informational content displayed on the screen on the basis of an activation of the first input device. By means of the switching device, the doctor is enabled, in a relatively simple way, to switch the operating device according to the invention from a first operating mode, in which the first operating device is usable to move the first robot arm manually, to a second operating mode, in which the first input device is usable to change the informational content displayed on the screen. The switching device is implemented for example as a foot switch, which allows the doctor to operate the operating device according to the invention relatively simply. The switching device may also be designed to be speech-controlled.

The control device may be designed in such a way that it generates a third signal on the basis of an activation of the switching device, so that a robot arm of the medical work station provided for treating the living being executes a movement corresponding to the manual movement. According to this variant, the doctor is enabled to use the first input device to move the first or second robot arm, as well as to change the informational content displayed on the screen, through relatively simple switching.

According to one variant of the operating device according to the invention, its first input device is of force-controlled or force feedback design. In connection with the variant according to which the first input device is used to change the informational content displayed on the screen, improved and/or more convenient changing of the displayed informational content by means of the first input device results, since relevant information can be represented in tactile form. The force-controlled or force feedback design can simplify for example navigating or representing supplied tactile information.

One example of an exemplary embodiment of the invention is depicted in the attached schematic drawings. The figures show the following:

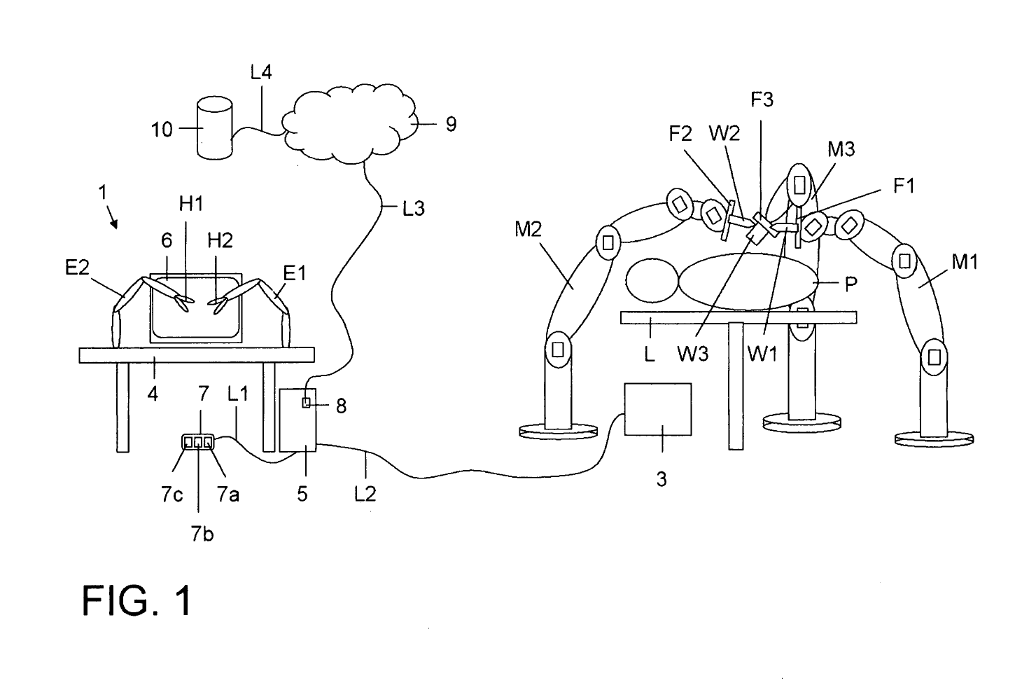

FIG. 1 a medical work station with a plurality of robot arms and an operating device for moving the robot arms manually, and

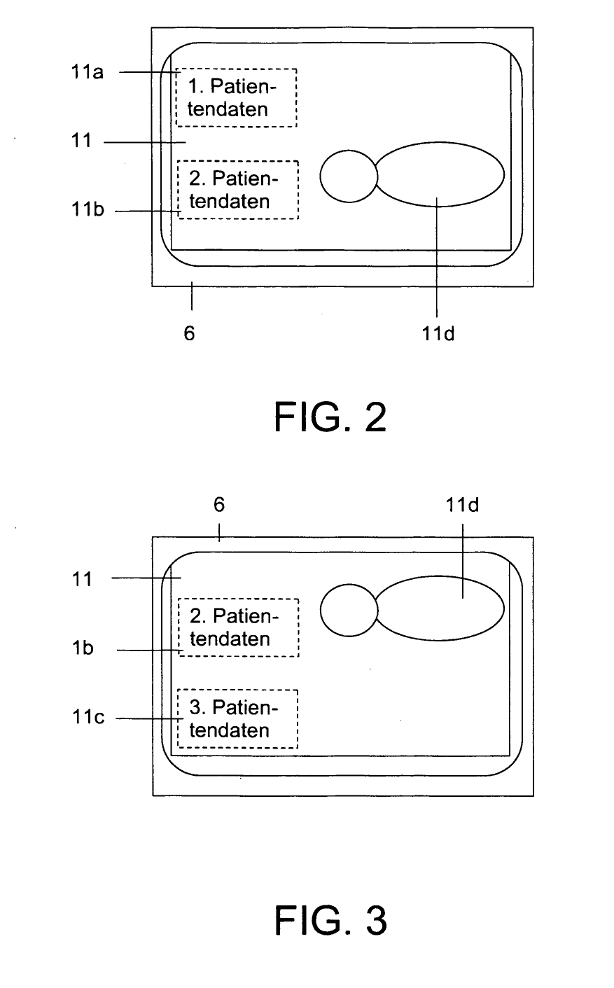

FIGS. 2 and 3 informational contents displayed with a display screen of the operating device.

FIG. 1 shows a medical work station which has a patient table L, a plurality of robot arms M1-M3 and an operating device 1 for moving robot arms M1-M3 manually. Each of the robot arms M1-M3 has a plurality of axes that are movable by means of drives and an attaching device F1-F3, and is movable for example with reference to six degrees of freedom.

In the case of the present exemplary embodiment, lying on patient table L is a person P, who may be treated by means of robot arms M1-M3, or by means of instruments attached to the attaching devices F1-F3 of robot arms M1-M3. Attached to each of the attaching devices F1, F2 of robot arms M1, M2 are for example medical instruments W1, W2, and attached to the attaching device F3 of robot arm M3 is for example a camera W3.

In the case of the present exemplary embodiment, the drives of robot arms M1-M3, medical instruments W1, W2 and camera W3 are connected to a first control computer 3 in a manner not shown. Running on first control computer 3 is a computer program by means of which control computer 3 is able to activate the drives of robot arms M1-M3 in such a way that the axes of robot arms M1-M3 move in a desired manner, so that the attaching devices F1-F3 or the tool center points of medical instruments W1, W2 and of camera W3 assume a desired location (position and orientation).

The medical work station also includes operating device 1. In the case of the present exemplary embodiment, the latter has a second control computer 5, two manual input devices E1, E2 situated on a table 4 and connected to second control computer 5 in a manner not shown, a display screen connected to second control computer in a manner not shown, and a foot-operated switchover device 7 connected to second control computer 5 by means of a cable L1. In addition, the two control computers 3, 5 are able to communicate with each other via a data line L2.

In the case of the present exemplary embodiment, the two manual input devices E1, E2 each have a handgrip H1, H2 and a plurality of axes. A doctor, not shown in further detail in the figures, is able to move manual input devices E1, E2 manually with reference to at least six degrees of freedom, using handgrips H1, H2. Manual input devices E1, E2 have for example angle sensors assigned to the respective axes of manual input devices E1, E2 and not depicted in further detail in the figures, whose signals are conveyed to second control computer 5. Running on second control computer 5 in turn is a computer program that recognizes movements of manual input devices E1, E2 on the basis of the signals originating from manual input devices E1, E2. The two manual input devices E1, E2 may also have more than six degrees of freedom.

In the case of the present exemplary embodiment, manual input device E1 is provided to move robot arm M1. When manual input device E1 is moved manually by means of its handgrip E1, the angle sensors of manual input device E1 detect angular changes of the relevant axes. From the signals generated by the angle sensors, second control computer 5 ascertains corresponding movements of manual input device E1 and transmits via cable L2 a corresponding notification to first control computer 3, which thereupon activates the drives of robot arm M1 in such a way that its attaching device F1 or its tool center point executes a movement corresponding to the manual movement of manual input device E1. The signals may also be pre-processed, e.g., filtered.

In the case of the present exemplary embodiment, manual input device E2 is provided to move the two other robot arms M2, M3. To select one of the two robot arms M2, M3 for the movement, the doctor may activate foot-operated switchover device 7. The latter has three foot switches 7a, 7b, 7c. If the doctor for example activates foot switch 7a with his foot, then he is able to move robot arm M2 with manual input device E2, similar to the way he is able to move robot arm M1 with manual input device E1. If the doctor instead activates foot switch 7b with his foot, then he is able to move robot arm M3 with manual input device E2, similar to the way he is able to move robot arm M1 with manual input device E1.

In the case of the present exemplary embodiment, camera W3, with which pictures of the operation situs may be taken, is attached to robot arm M3, so that the doctor obtains for example optical feedback about the locations of robot arms M1, M2 and/or of medical instruments W1 and/or W2 assigned to the robots. The image data records associated with the pictures taken with camera W3 are transmitted via cable L2 from first control computer 3 to second control computer 5, so that second control computer 5 is able to display these images on screen 6, after processing if appropriate.

In the case of the present exemplary embodiment, second control computer 5 of operating device 1 has an interface 8 via which second control computer 5 is able to communicate with a hospital data network 9. To that end, interface 8 is connected to hospital data network 9 via a data line L3. The hospital data network in turn is connected to a database 10 via a data line L4. Among other information, data associated with living being P are stored in electronic form in database 10, for example that person's patient file 11.

In the case of the present exemplary embodiment, operating device 1 is also set up in such a way that data may be retrieved through interface 8 via hospital data network 9, and in particular from database 10, so that for example the patient file 11 of living being P can be displayed on screen 6 of operating device 1, as shown in FIGS. 2 and 3.

Furthermore, operating device 1 is set up so that by operating foot-operated switchover device 7, and in particular by activating switch 7c, the doctor is able with manual input device E2 to retrieve data from database 10 instead of moving robot arms M2, M3. To that end, in the case of the present exemplary embodiment manual input device E2 or second control computer 5 is set up in such a way that second control computer 5 recognizes a predefined movement of manual input device E2 as the instruction to retrieve data from database 10. Second control computer 5 is also set up so that as soon as informational content associated with the retrieved data is displayed on screen 6, such as for example the patient file 11 shown in FIGS. 2 and 3, it is possible for example to change the displayed informational content, for example in the form of navigating within patient file 11 on the basis of a manual movement of manual input device E2.

In the case of the present exemplary embodiment, patient file includes 1st patient data 11a, 2nd patient data 11b, 3rd patient data 11c and an image 11d of living being P taken using an imaging medical device, which is for example an x-ray image, a CT image or an MR image or an ultrasound image.

In the case of the present exemplary embodiment, by moving manual input device E2 the doctor is enabled to scroll the patient file 11 depicted on screen 6 and shown in FIGS. 2 and 3 downward and upward, in particular in order to be able to read the text of patient file 11. To that end, second control computer 5 interprets the signals of the angle sensors generated on the basis of the manual movement of manual input device E2 and activates screen 6 accordingly, in order to enable the forenamed scrolling of patient file 11 depicted in FIGS. 2 and 3. In addition or alternatively, it is also possible to change the depiction of image 11d on the basis of a manual movement of manual input device E2. To that end, second control computer 5 for example is set up so as to rotate the depicted image 11d on the basis of a movement of manual input device E2, in order to display it in various views or to show various cross sections. In particular, superimposition with the images taken by camera W3 is possible.

In the case of the present exemplary embodiment, the two manual input devices E1, E2 are in addition force-controlled, and include to that end for example electric drives, not depicted in the figures, connected to the axes of manual input devices E1, E2, in order for example to compensate for a weight of manual input devices E1, E2 or to be able to give the doctor tactile feedback when moving robot arms M1-M3 and/or navigating and/or changing patient file 11.

In addition or alternatively, it is also possible to also switch over manual input device E1 so that it may be used to retrieve data from database 10 through interface 8 of second control computer 5 and/or in order to use input device E1 to change the informational content displayed on screen 6, such as patient file 11.

1. An operating device for manually moving a robot arm of a medical work station, having
a control device (5) which is set up to generate a first signal intended to control a movement of a first robot arm (M2) provided for treating a living being (P),
a manual first input device (E2) coupled with the control device (5), where the first control device (5) generates the first signal on the basis of a manual movement of the first input device (E2), so that the first robot arm (M2) executes a movement corresponding to the manual movement, and
a display screen (6),
wherein the control device (5) has an interface (8) which is intended to be connected to a hospital data network (9), and the control device (5) is set up to retrieve data associated with the living being (P) via the interface (8) and the hospital data network (9) and to display informational content (11) associated with the data on the screen (6).

2. The operating device according to claim 1, whose first input device (E2) has more degrees of freedom than the first robot arm (M2).

3. The operating device according to claim 1 or 2, whose control device (5) and first input device (E2) are set up to change the informational content (11) displayed on the screen (6) by means of the first input device (E2).

4. The operating device according to one of claims 1 through 3, having a manual second input device (E1) coupled with the control device (5), the control device (5) being set up to generate a second signal based on a manual movement of the second input device (E1), on the basis of which a second robot arm provided to treat the living being (P) executes a movement corresponding to the manual movement of the second input device (E1), the control device (5) and the second input device (E1) being set up to change the informational content (11) displayed on the screen (6) by means of the second input device (E1).

5. The operating device according to claim 3 or 4, having a switching device (7) coupled with the control device (5), wherein the control device (5), on the basis of an activation of the switching device (7), either generates the first signal on the basis of the manual movement of the first input device (E2), or via the interface (8) retrieves and/or changes the informational content (11) displayed on the screen (6) on the basis of an activation of the first input device.

6. The operating device according to claim 5, whose control device (5) is designed in such a way that it generates a third signal on the basis of an activation of the switching device (7), so that a third robot arm (M3) provided for treating the living being (B) executes a movement corresponding to the manual movement.

7. The operating device according to one of claims 3 through 6, whose first input device (E2) is of force-controlled or force feedback design.

8. The operating device according to one of claims 1 through 7, wherein the data associated with the living being (P) are stored in a database (10) of the hospital data network (9), and the control device (5) is set up to retrieve these data from the database (10) via the interface (8).

9. The operating device according to one of claims 1 through 8, wherein the data are assigned to a clinical record (11) of the living being (P).

10. The operating device according to one of claims 1 through 9, wherein the data have been created prior to a treatment of the living being (P) with the first robot arm (M2).

11. A medical work station, having an operating device (1) according to one of claims 1 through 10 and at least one medical robot arm (M1-M3) provided for treating the living being (P), the motion of the robot arm being controllable manually by means of the operating device (1).
